(19) United States
(12) Patent Application Publication
(10) Pub. No.: US 2017/0133813 A1
(43) Pub. Date: May 11, 2017

(54) LASING GAS RECYCLING

(71) Applicant: Transformation Point Technologies, LLC, Easton, PA (US)

(72) Inventor: John Weyrauch, Easton, PA (US)

(73) Assignee: Transformation Point Technologies, LLC, Easton, PA (US)

(21) Appl. No.: 15/345,915

(22) Filed: Nov. 8, 2016

Related U.S. Application Data
(60) Provisional application No. 62/252,786, filed on Nov. 9, 2015.

(51) Int. Cl. H01S 3/036; B01D 46/00; H01S 3/22; B01D 53/02

(52) U.S. Cl. CPC H01S 3/036; B01D 53/02; B01D 46/008; H01S 3/2222; B01D 2253/102; B01D 2257/108; B01D 2257/11

(57) ABSTRACT

A gas recycling system includes a series of removal units configured to receive a flow of contaminated lasing gas and output a flow of purified neon gas, the units include a set of filters that remove fouling elements from the flow of contaminated lasing gas; a first set of parallel trap modules that remove hydrogen from the flow of contaminated lasing gas; and a second set of parallel trap modules that remove xenon from said flow of contaminated lasing gas; and a storage vessel that receives said flow of purified neon gas from at least one of the plurality of removal units.

### CROSS-REFERENCE TO RELATED APPLICATIONS

The present application claims the benefit of the filing date of U.S. Provisional Patent Application No. 62/252,786 filed Nov. 9, 2015, the disclosure of which is hereby incorporated herein by reference.

### BACKGROUND OF THE INVENTION

The present invention relates to a lasing gas recycling; or, more particularly, to the recycling of neon gas that has been discharged from an excimer laser.

Excimer lasers generate laser action from a high purity lasing gas. A typical lasing gas is comprised of at least one part noble gas (e.g., argon, krypton, xenon, neon, etc.), one part halogen gas (e.g., chlorine or fluorine), and one part buffer gas (e.g., helium). The lasing gas is stimulated within a lasing chamber to generate laser action. During operation of the laser, some portion of the halogen gas is depleted by reaction with materials inside of the chamber (e.g., hydrogen chloride). Impurities are introduced as the halogen gas is depleted. These impurities can reduce the output power of the laser via light absorption, scattering, and degradation. In some instances, output power can be significantly reduced by concentrations of impurities as low as 0.1% (1000 ppm) of the lasing gas.

The output power of a laser can be at least partially restored by replacing the depleted halogen in the lasing chamber. Most lasers cannot, however, be restored to full output power without removing said impurities from the lasing chamber. Thus, all of the lasing gas is typically discharged from the lasing chamber at some point, including any noble gases contained therein. Sources of noble gas are rare on earth, making supplies inherently limited. Noble gases are also expensive to purify, when found. Continual demand for lasing technologies has also caused global shortages of most purified noble gases, such as helium and neon, further exacerbating their cost. As a result, it has become increasingly expensive to operate gas discharge lasers because of the costs associated with having to continually replace high purity noble gases when removing contaminants from the lasing chamber.

Attempts have been made to reduce these costs by re-purifying at least a portion of the discharged noble gas. Many known processes utilize extreme temperature fluctuations. For example, some purification processes use cryogenic traps to condense certain impurities (e.g., carbon tetrachloride) by cooling the discharged lasing gas from room temperature to a reaction temperature of between 90 to 130° K (or between -298 to -225° F.) and then heating it back up. In other examples, certain contaminants (e.g., nitrogen or water) are removed by a catalytic process, wherein the discharged lasing gas may be heated from room temperature to a reaction temperature of between 250 to 700° C. (or between 482 to 1,292° F.) and then cooled back down. These types of processes are common.

Utilizing processes that require extreme temperature fluctuations can increase the cost and complexity of the underling mechanical systems. Therefore, most of these processes are suitable for industrial scale purification, yet unworkable in situ. Moreover, many of these processes can only be realized with either permanent equipment having an extensive footprint, such as a cooling tower; or costly modifications to existing lasers, such as having to convert a laser from one input of lasing gas to another. Because of their complexity, many of these processes also require considerable technical support to ensure their continued operation, adding even more costs.

### SUMMARY OF THE INVENTION

A gas recycling system comprises a series of removal units configured to receive a flow of contaminated lasing gas and output a flow of purified neon gas, the units comprising: a set of filters that remove fouling elements from the flow of contaminated lasing gas; a first set of parallel trap modules that remove hydrogen from the flow of contaminated lasing gas; and a second set of parallel trap modules that remove xenon from said flow of contaminated lasing gas; and a storage vessel that receives said flow of purified neon gas from at least one of the plurality of removal units.

A gas recycling process comprising moving a flow of contaminated lasing gas through a series of removal units including a set of filters that remove a fouling element from the flow of contaminated lasing gas; a first set of traps that remove at least hydrogen from the flow of contaminated lasing gas; and a second set of traps that remove at least xenon from said flow of contaminated lasing gas; outputting a flow of purified neon gas from one of the series of removal units; and blending the flow of purified neon gas with at least one blending gas so as to create a lasing gas.

A neon gas purification kit comprising a series of removal units configured to receive a flow of contaminated lasing gas and output a flow of purified neon gas, said removal units including a plurality of filters configured to remove fouling elements from the flow of contaminated lasing gas; at least one first set of traps configured to remove at least hydrogen from the flow of contaminated lasing gas; and at least one second set of traps configured to remove at least xenon from said flow of contaminated lasing gas; and one or more moving elements configured to move said flow of contaminated lasing gas through the series of removal units, wherein each filter and trap is independently removable.

### BRIEF DESCRIPTION OF THE DRAWINGS

FIG. 1 provides a flow diagram of an exemplary embodiment of a process according to the present invention.

FIG. 2 provides a flow diagram of an exemplary stage of the process according to the FIG. 1.

FIG. 3 provides a flow diagram of another exemplary stage of the process according to the FIG. 1.

FIG. 4 provides a flow diagram of yet another exemplary stage of the process according to the FIG. 1.

FIG. 5 provides a flow diagram of still yet another exemplary stage of the process according to the FIG. 1.

FIG. 6 provides a flow diagram for a collection stage of contaminated lasing gases from a bank of lasers.

FIG. 7 provides a flow diagram of another exemplary embodiment of a process according to the present invention.

### DETAILED DESCRIPTION

The present invention pertains to the recycling of a noble gas that has been discharged from a laser within a flow of contaminated lasing gas. In the follow paragraphs, various exemplary systems, processes, kits, and related inventions are described with reference to the recycling of a flow of contaminated lasing gas that has been discharged from an excimer laser. Said gas flow is described as having one part noble gas and one part halogen gas. In each example, the laser is a hydrogen chloride excimer laser that generates laser action from a lasing gas, wherein the noble gas is neon and the halogen gas is hydrogen chloride. These neon-specific examples are provided for ease of description as the present invention is not limited to a particular type of laser or lasing gas.

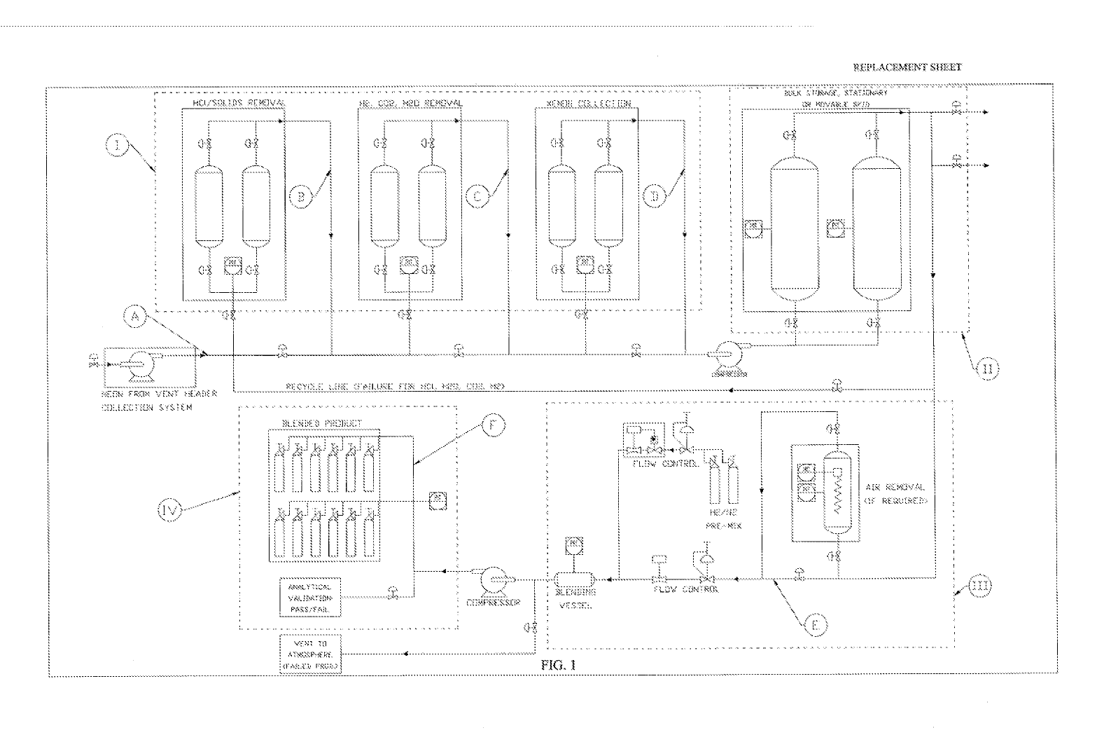

One embodiment of the present invention is illustrated in FIG. 1 as a system 10. Although not required, system 10 is preferably embodied a standalone device that is stored on a moveable object, such as pallet or truck, for one-site delivery to an installed laser. As shown in FIG. 1, a flow of contaminated lasing gas is then delivered to system 10 at point A and then moved through points B through F of system 10 in four exemplary stages, such as:

(I) a removal stage (points B-D);

(II) a storage stage (point D);

These units can also be arranged at the front end of the process.

(III) a processing stage (point E); and

(IV) a packaging stage (point F).

Exemplary realizations of each stage I-IV are illustrated, respectfully, in FIGS. 1-5 and now described in turn.

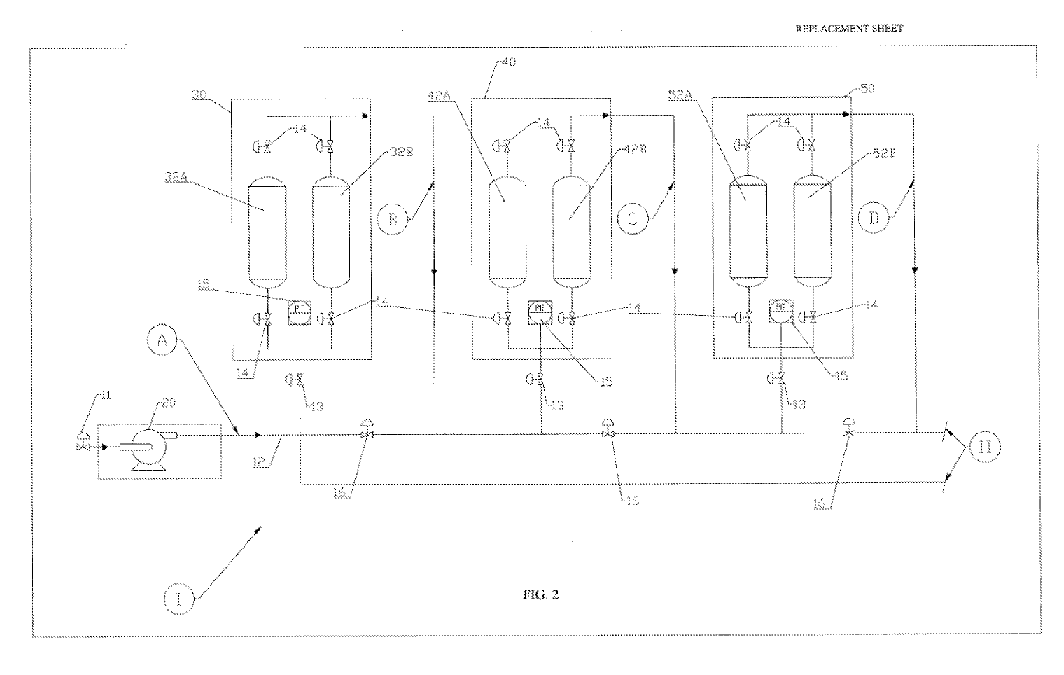

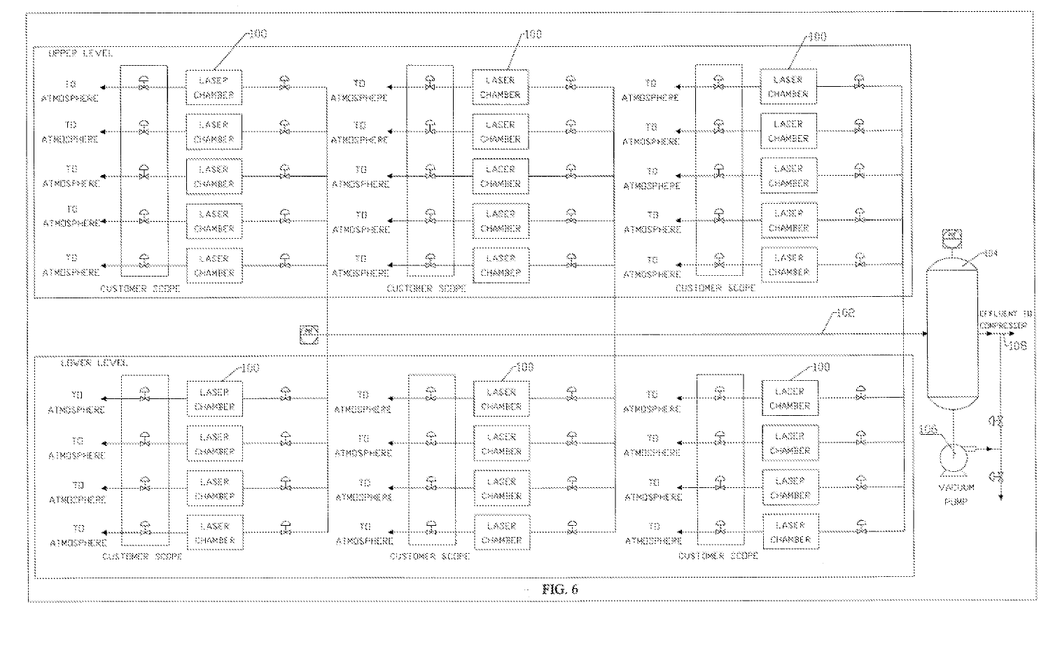

First as shown in FIG. 6, banks of lasers 100 are connected in parallel to a common conduit 102. The conduit 102 supplies the contaminated lasing gas from any one of the lasers to a ballast tank 104. The ballast tank reduces the lasing gas pressure by allowing the gas to expand. Transfer of the contaminated lasing gas to the tank 104 may be by any super means, for example, such as the use of a vacuum pump 106, or by the pressure of the lasing gas. The output conduit 108 from the tank 104 feeds the contaminating lasing gas to the hookup 11 proceeding element 20, for example, a vacuum pump as shown in FIG. 2.

One embodiment of removal stage (I) is illustrated in FIGS. 1-2. As shown in FIG. 1, system 10 has a hookup 11 configured to directly receive the flow of contaminated lasing gas or from the ballast tank 104 as shown in FIG. 6. Hookup 11 may be realized as a interchangeable set of connection fittings, such as connectors, valves, and the like. Any fitting type may be used so that system 10 may receive contaminated lasing gas from any source. Hookup 11 of FIG. 2 is releasably connected to the lasing chamber of an excimer laser (not shown). In operation, the contaminated lasing gas flows from hookup 11 and into the various elements of system 10 through a conduit 12 that may be any type of pipe, tube, or other flow device.

In a low flow embodiment of system 10, the flow rate of contaminated lasing gas moving through removal stage (I) is determined by the pressure of the lasing gas in the lasing chamber. If the gas pressure is sufficiently high, then this configuration may desirably reduce system complexity. In other embodiments, such as in FIGS. 1-2, a moving element 20, such as a pump or compressor, is configured to move a flow of contaminated lasing gas through removal stage (I). Element 20 in FIG. 2, for example, is a vacuum pump utilized to move the flow of contaminated lasing gas from the lasing chamber, through hookup 11, and into the removal units described below.

Point A is marked on FIGS. 1-2. An exemplary set of feed stream characteristics for the contaminated lasing gas at point A is set forth below. In this example, neon gas is being recycled from a flow of contaminated lasing gas discharged from the lasing chamber of a hydrogen chloride excimer laser. The feed stream characteristics of the contaminated lasing gas at point A of FIGS. 1-2 are:

| | |
|---|---|
| Neon (%) | >99.4% |
| HCL (ppm) | <5 |
| H2O (ppm) | <650 |
| CO2 (ppm) | <100 |
| H2 (ppm) | <250 |
| Xe (ppm) | <4800 |
| Metal Cl's (ppm) | <1 |
| Metal O2's (ppm) | <1 |
| F (slpm) | <250 |
| T (° C.) | <40 |
| P (psig) | <85 |

In the removal stage (I), this flow of contaminated lasing gas is moved from point A and through removal units 30, 40, and 50 (FIGS. 1-2) in order to remove certain, targeted contaminants.

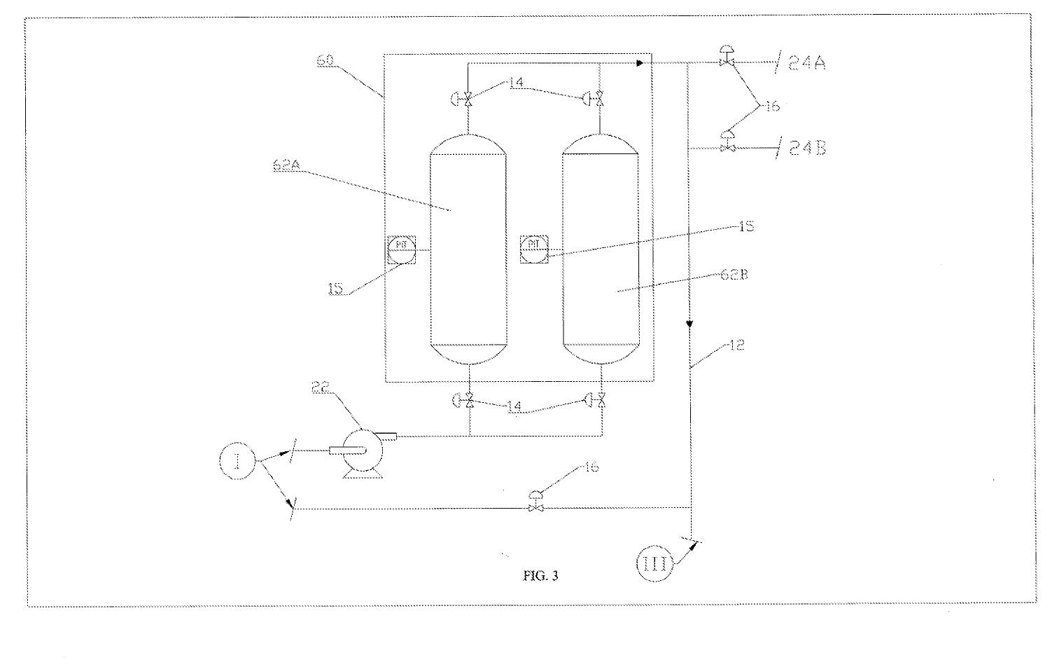

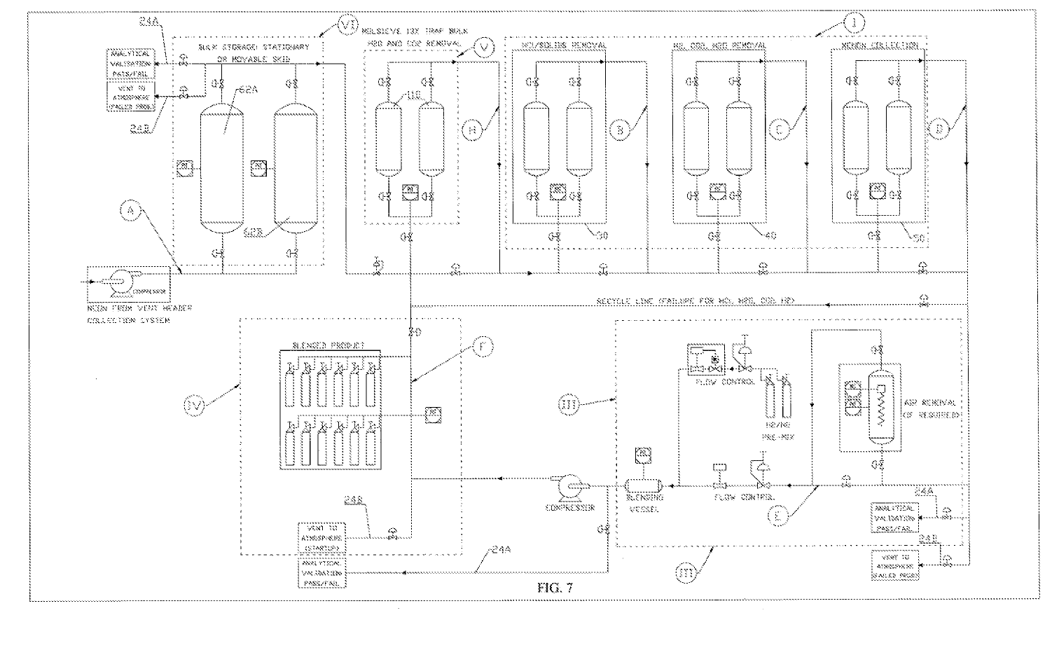

In an alternative embodiment as shown in FIG. 7, the contaminated lasing gas prior to being supplied to removal units 30, 40, and 50 in removal stage (I), may be supplied to a bulk storage stage (VI) which comprises a first storage vessel 62A and a second storage vessel 62B installed in parallel in a similar manner as to be described hereinafter with respect to the storage stage (II) as shown in FIG. 3. The contaminated lasing gas exiting from the storage stage (VI) first passes through a processing stage (V) which includes one or more molsieve No. 13X traps 110 which are arranged in parallel. The traps 110 remove bulk water and/or carbon dioxide from the contaminated lasing gas before being processed through the remaining removal units of removal stage (I).

Removal units 30, 40, and 50 of FIG. 2 are depicted in FIGS. 1-2 as being installed in series. The flow of gas is preferably routed first through unit 30. In FIG. 2, for example, the filtered flow of contaminated lasing gas is moved through linearly through removal units 30, 40, and 50 by moving element 20. A flow of purified noble gas having the characteristics of point D is then output from one of the removal units 30, 40, or 50. The number of removal units is also not critical. For example, a portion of conduit 12 may be modified to include one or more expansion ports, thereby allowing removal stage (I) to be expanded by adding additional removal units.

Before unit 30, as discussed above, there may be a set of traps 110. The specifications of the lasing gas at point H are as follows:.

| | |
|---|---|
| Ne (%) | >99.49% |
| HCL (ppm) | <5 |
| H2O (ppm) | <10 |
| CO2 (ppm) | <5 |
| H2 (ppm) | <250 |
| Xe (ppm) | <4800 |
| Metal Cl's (ppm) | <1 |
| Metal O2's (ppm) | <1 |
| F (slpm) | <250 |
| T (° C.) | <40 |
| P (psig) | <85 |

Removal unit 30 of FIG. 2 performs a filtration step that prevents fouling of the downstream elements of system 10. The illustrated embodiment has a first filter 32A installed in parallel with a second filter 32B. Each filter 32A and 32B in FIG. 2 is attached to unit 30 by a set of removable connector valves 14. Because filters 32A-B are installed in parallel between a pair of removable connector valves 14, each filter is independently removable, that is, removable from system 10 without disrupting the system operation. Filters 32A-B are constructed of 316LSS (or Hastelloy) and contain an adsorptive media that specifically targets hCl removal.

However constructed, at least a portion of each filter 32A-B may be removed for replacement or regeneration after a predetermined amount of contaminated lasing gas flows therethrough. The PIT symbols 15 represented in the drawings are pressure indicators, such as digital indicators. A control valve 16 is utilized to seal unit 30 from units 40 and 50, if needed.

Each filter 32A and 32B in FIG. 2 is, for example, configured to accept the flow of contaminated lasing gas from point A, remove the hydrochloric acid and solids (specifically metal chlorides and oxides) therefrom, and deliver the gas to point B. According to the above example set forth above, a set of feed stream characteristics at point B is:

| | |
|---|---|
| Neon (%) | >99.94% |
| HCL (ppm) | <1 |
| H2O (ppm) | <10 |
| CO2 (ppm) | <5 |
| H2 (ppm) | <250 |
| Xe (ppm) | <4800 |
| Metal Cl's (ppm) | <1 |
| Metal O2's (ppm) | <1 |
| F (slpm) | <250 |
| T (° C.) | <40 |
| P (psig) | <85 |

As shown, the amount of hydrochloric acid in the flow of contaminated lasing gas has been reduced to appropriate levels. The contaminated lasing gas flows into and out of filters 32A-B at the same temperature and pressure, thereby allowing the same conduit 12 to be used throughout system 10. The pressure inside of each filter 32A and 32B may be controlled upstream by a regulator.

Removal unit 40 of FIG. 2 comprises a first trap 42A and a second trap 42B. Similar to above, each of traps 42A and 42B is installed in parallel with one another, between another set of removable connector valves 14. As a result, each trap 42A-B is independently removable from unit 40. Each trap 42A-B of FIG. 2 also contains an adsorbent surface that removes at least one contaminant from the flow of contaminated lasing gas by physical adsorption. An exemplary adsorbent surface may made of a carbon-based material that utilizes van der walls forces to trap the molecules of said one or more contaminants thereon. Because they are independently removable, each of trap 42A-B may be regenerated or replaced after a predetermined amount of contaminated lasing gas flows therethrough.

Each of traps 42A-B in FIG. 2, for example, has an adsorbent surface configured to remove at least water, carbon dioxide, and hydrogen from said flow of contaminated lasing gas by physical adsorption. Each traps 42A-B may be embodied as a MictoTorr purifier, manufactured by SEAS Pure Gas, Inc., having a model number MC4500-902F. As shown in FIGS. 1-2, the flow of contaminated lasing gas moves from point B and through traps 42-B to point C. To continue with the above example, an exemplary set of feed stream characteristics at point C are:

| | |
|---|---|
| Neon (%) | >99.52% |
| HCL (ppm) | <1 |
| H2O (ppm) | <1 |
| CO2 (ppm) | <1 |
| H2 (ppm) | <1 |
| Xe (ppm) | <4800 |
| Metal Cl's (ppm) | <1 |
| Metal O2's (ppm) | <1 |
| F (slpm) | <250 |
| T (° C.) | <40 |
| P (psig) | <85 |

As shown, the amount of water, carbon dioxide, and hydrogen in the flow of contaminated lasing gas has been reduced to appropriate levels. The predetermined maximum amount of contaminated lasing gas for traps 42A-B in this example is approximately equal to a volume of 315,000 liters. Said gas is input to and output from traps 42A-B at the same temperature and pressure, thereby allowing use of conduit 12.

Removal unit 50 of FIG. 2 similarly comprises a first trap 52A and a second trap 52B installed in parallel. Each trap 52A-B has an adsorbent surface configured to remove at least one contaminant from said flow of contaminated lasing gas by chemical adsorption. Traps 52A and 52B of FIG. 2 are installed between yet another set of removable connector valves 16 and are, thus, independently removable from unit 50. Similar to above, each of traps 52A-B is removed for regeneration or replacement after a predetermined maximum amount of contaminated lasing flows therethrough.

In contrast to above, however, the use of chemical absorption in traps 52A-B allows one or more contaminants to be recovered their adsorbent surfaces in a purified form. Each of traps 52A-B in FIG. 2, for example, has an adsorbent surface configured to remove xenon. An exemplary adsorbent surface may made of another carbon-based material, such as Norit® GCA-48 activated carbon. As shown in FIG. 2, a flow of contaminated lasing gas is input to unit 50 from point C, while a flow of purified noble gas is output therefrom at a point D. To continue the above example, an exemplary set of feed stream characteristics at point D are:

| | |
|---|---|
| Neon (%) | >99.999% |
| HCL (ppm) | <1 |
| H2O (ppm) | <1 |
| CO2 (ppm) | <1 |
| H2 (ppm) | <1 |
| Xe (ppm) | <1 |
| Metal Cl's (ppm) | <1 |
| Metal O2's (ppm) | <1 |
| F (slpm) | <250 |
| T (° C.) | <40 |
| P (psig) | <85 |

As shown, the amount of xenon in the gas flow has been significantly reduced. The predetermined maximum amount of Xenon for traps 52A and 52B in this example is approximately equal to 21,000 liters. Additional sets of traps 52A-B may be used to ensure that predetermined maximum amount for unit 50 is approximate equal to that of units 30 and 40. Gas is input to and output from unit 50 at the same temperature and pressure. Process steps for recovering xenon are described below.

According to process described herein, a flow of purified noble gas is output from point D without the associated complexity of cryogenic traps, catalytic processes, or the like. Within storage stage (II), a volume of said flow of purified noble gas is stored, at least temporarily, within system 10. An exemplary storage stage (II) is illustrated in FIG. 3 with reference to a storage unit 60. As shown, unit 60 comprises a first storage vessel 62A and a second storage vessel 62B installed in parallel between another set of removable connector valves 14. Thus, as before, each of said vessels is independently removable to permit bulk storage of the purified noble gas. A moving element 22, a vacuum compressor in this instance, is utilized to move the flow of purified noble gas into the vessels 62A and 62B at a desired pressure. Each of vessels 62A-B in FIG. 3 is, for example, a 400 gallon pressure vessel having a maximum capacity of about 22,000 liters. Another pit 15 is attached to each of said vessels for like purposes as above. Unit 60 is attached to an exit port 24A and an exit port 24B. Exit port 24A moves a portion of the purified noble gas to a validation sensor configured to verify its purity, while exit port 24B is an exhaust port. Once stored, a steady flow of purified noble gas is made available from unit 62A/B.

In processing stage (III), the steady flow of purified noble gas is supplied from storage stage (II). In the embodiment shown in FIG. 7, steady flow of purified noble gas from the xenon collection unit 50 is supplied directly to the processing stage (III). In this embodiment, the storage stage (II) has been eliminated to allow direct flow of the purified noble gas from removal stage (I) to the processing stage (III). An exit port 24A may move a portion of purified noble gas to a validation sensor configured to verify its purity, while exit port 24B is an exhaust port.

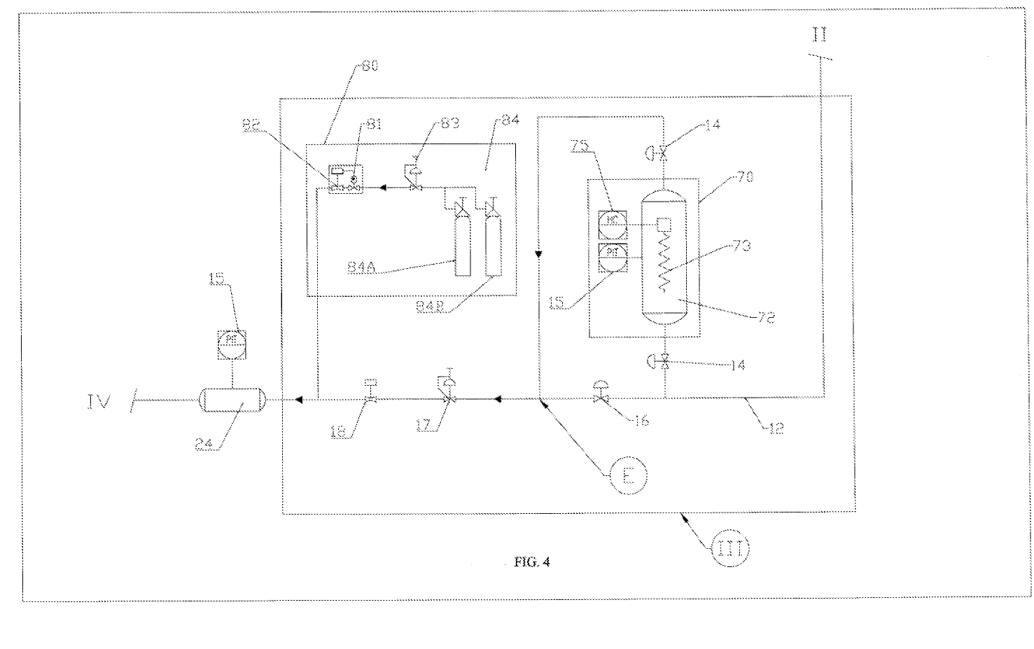

An exemplary processing stage (III) is illustrated in FIG. 4, wherein system 10 further comprises an air removal unit 70 and a blending source unit 80. Air removal unit 70 is optional; when present, unit 70 comprises at least one tank 72, with a heating element 73, and a control device 75. At least one control valve 16 and one or more removable connector valves 14 are placed adjacent unit 70 so that it is independently removable, if unwanted. In operation, unit 70 removes a remaining amount of air from the steady flow of purified noble gas by direct heating. Accordingly, to continue the above example, an exemplary set of feed stream characteristics at point E are:

| | |
|---|---|
| Neon (%) | >99.999% |
| HCL (ppm) | <1 |
| H2O (ppm) | <1 |
| CO2 (ppm) | <1 |
| H2 (ppm) | <1 |
| Xe (ppm) | <1 |
| Metal Cl's (ppm) | <1 |
| Metal O2's (ppm) | <1 |
| F (slpm) | <100 |
| T (° C.) | <40 |
| P (psig) | <85 |

As shown, the flow rate of purified noble gas at point E has been reduced by air removal unit 70 to permit blending. A pressure regulating valve 17 is used to further direct said flow of gas through a blending source valve 18.

To complete processing stage (III), the flow of purified noble gas from point E is mixed with one or more gases flowing from blending source unit 80. As shown in FIG. 4, an exemplary source unit 80 comprises a flow controller 81 with a blending source valve 82, a pressure regulating valve 83, and a blending gas source 84. Flow controller 81 and valve 82 are utilized to combine the blending gas flowing from source 84 with the purified noble gas flowing from blending source valve 18. The combined gas flow is directed into a blending vessel 24, wherein the newly blended lasing gas is temporarily stored, thereby completing this embodiment of processing stage (III). Blending vessel 24 has another pit 15 attached thereto.

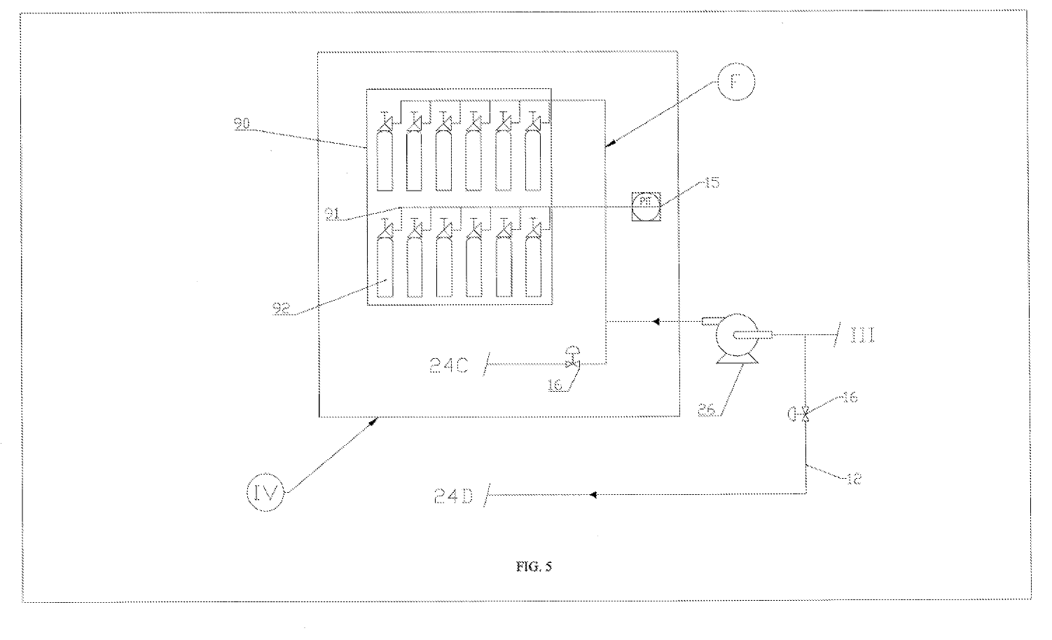

Packaging stage (IV) converts the purified gas output from processing stage (III) into an immediately useable form. An exemplary packaging stage (IV) is illustrated in FIG. 5. As shown, another moving element 26 moves the lasing gas from blending vessel 24, through conduit 12, and into a packaging unit 90. The exemplary unit 90 of FIG. 5 has a manifold 91 connected to a plurality of lasing gas storage containers 92 and another pit 15. Blending vessel 24 preferably acts as a buffer tank so that compressor 26 is only activated after vessel 24 is filled, thereby ensuring a steady flow of lasing gas. Moving element 26 of FIG. 5 is shown as a two stage triple diaphragm compressor.

The ongoing example is specific to neon gas. Therefore, as shown in FIG. 4, blending gas source 84 comprises a first blending gas storage canister 84A containing helium (H₂) and a second blending gas storage canister 84B containing nitrogen (N₂). Thus, after blending inside of vessel 24, the lasing gas at point F of FIG. 5 now has the following characteristics:

| | |
|---|---|
| Neon (%) | >99.99% |
| HCL (ppm) | <1 |
| H2O (ppm) | <1 |
| CO2 (ppm) | <1 |
| H2 (ppm) | <100 (+/−5) |
| Xe (ppm) | <1 |
| Metal Cl's (ppm) | <1 |
| Metal O2's (ppm) | <1 |
| F (slpm) | <1500 |
| T (° C.) | <40 |
| P (psig) | <0-2400 |

Accordingly, an amount of neon has been captured from a flow of contaminated lasing gas (point A), blended with another gas to create a lasing gas (point E), and then packaged for immediate use by a specified excimer laser (point F).

Blending vessel 24 is attached to an exit port 24C that permits access to a validation sensor configured to verify the purity of lasing gas at point F. Moving element 26 is attached to an exit port 24D that allows a volume of the purified gas to be purged during start-up, for example. A control valve 16 is attached to ports 24C and 24D. A total of twelve tanks 92 are shown in FIG. 5, although any number may be used. Each tank 92 is preferably embodied as a 12×49 liter steel cylinder that may be releasably attached to a lasing chamber so as to provide a steady supply of purified, pre-mixed lasing gas thereto. Manifold 91 allows for groups of said plurality of tanks 92 to be installed in parallel, thereby allowing any one tank 92, or group of said tanks, to independently removable.

An exemplary set of gas purification processes are also enabled by the description of system 10 set forth above and illustrated in FIGS. 1-5. An exemplary process for recycling a noble gas from a flow of contaminated lasing gas may comprise moving said flow through a series of removal units. Any pump, compressor, or like moving element may be used to move said flow of gas. In accordance with the neon-specific examples set forth above, an exemplary series of removal units may comprise at least one unit 30, which has a set of filters 32A and 32B that remove fouling elements from a flow of contaminated lasing gas; at least one unit 40, which has a first set of traps 42A-B that remove at least hydrogen from the flow of contaminated lasing gas; and at least one unit 50, which has a second set of traps 52A-B that remove at least xenon from said flow of contaminated lasing gas. This process may further comprise outputting a flow of purified neon gas from one of units 30, 40, or 50, and blending said flow of purified neon gas with at least one other gas so as to create a lasing gas. Portions of the moving step may be performed at a constant temperature and pressure. In the described example, unit 30 has an acid filter configured to remove at least an amount of hydrochloric acid from the flow of contaminated lasing gas.

Each filter 32A-B has been described as independently removable. The respective core element of each filter may also be independently removable. Accordingly, this exemplary process may further comprise removing at least a portion of filters 32A-B; and replacing or regenerating said portion. The removal timing may be proportionate to the amount of contaminated lasing gas flowing across filters 32A-B or their respective core elements. Each of traps 42A-B and traps 52A-B has also been described as independently removable. The respective adsorbent surfaces said traps may also be independently removable. Either way, an exemplary process may further comprise removing at least either the first or second adsorbent surface; and replacing or regenerating said adsorbent surface. The removal timing may also be proportionate to the amount of contaminated lasing gas.

If xenon recovery is desired, the said process may further comprise removing at least one second adsorbent surface; exposing said second surface to a temperature variation; and capturing any xenon released from said surface. An embodiment of packing unit 90 may be incorporated into this exemplary process. For example, said process may further comprise packaging, with packaging unit 90, a stored volume of said lasing gas in at least one lasing gas storage container 92. This process may further comprise attaching the at least one lasing gas storage container 92 to a lasing chamber; and moving an amount of the stored volume of lasing gas into the lasing chamber. Container 92 may be directly attachable to a lasing chamber by, for example, an alternate embodiment of hookup 11.

Exemplary gas purification kits are also described with reference to the various embodiments of system 10 set forth above. 21. An exemplary kit may comprise a series of removal units configured to receive a flow of contaminated lasing gas and output a flow of purified noble gas. In accordance with examples set forth above, said removal units may comprise one more units 30, each having a plurality of filters 32A-B configured to remove fouling elements from the flow of contaminated lasing gas; one or more units 40, each having at least one first set of traps 42A-B configured to remove at least hydrogen from the flow of contaminated lasing gas; and one or more units 50, each having at least one second set of traps 52A-B configured to remove at least xenon from said flow of contaminated lasing gas; and one or more compressors or pumps, such as pump 20, that are configured to move said flow of contaminated lasing gas through the series of removal units 30, 40, and 50, wherein each filter and trap is independently removable from one of said removal units. Any number of additional traps or filters, or any additional length of conduit 12, may also be included.

Some kits according the present invention may allow for optional enhancements. For example, an exemplary kit may further comprise one or more digital flow meters configured to measure an amount of contaminated lasing gas flowing through each removal unit and communicate with a third party when said measurement approaches a predetermined maximum amount. Other kits may comprise an air removal unit 70. Still other kits may comprise one or more blending gas storage canisters 84A-B; and a processing unit configured to operate blending source valves 18 and 82 to as to blend the flow of purified noble gas with the blending gases contained in the one or more blending gas storage canisters so as to create a lasing gas.

Although the invention herein is described with reference to particular embodiments, it is to be understood that these embodiments are merely illustrative of the principles and applications of said invention. It is therefore to be understood that numerous modifications may be made to the illustrative embodiments and that other arrangements may be devised without departing from the spirit and scope of the present invention as defined by the appended claims.

1. A gas recycling system comprising:
a series of removal units configured to receive a flow of contaminated lasing gas and output a flow of purified neon gas, the units comprising:
a set of filters that remove fouling elements from the flow of contaminated lasing gas;
a first set of parallel trap modules that remove hydrogen from the flow of contaminated lasing gas; and
a second set of parallel trap modules that remove xenon from said flow of contaminated lasing gas; and
a storage vessel that receives said flow of purified neon gas from at least one of the plurality of removal units.

2. The system of claim 1, wherein each filter is independently removable from the system.

3. The system of claim 2, wherein each trap is independently removable from the system.

4. The system of claim 3, wherein each filter and trap is removed for regeneration or replacement after a predetermined maximum amount of contaminated lasing gas flows therethrough.

5. The system of claim 4, further comprising a flow measurement device configured to measure an amount of contaminated lasing gas flowing through each filter or trap and signal a third party when one of said measurements approaches a maximum amount.

6. The system of claim 1, wherein the first set of traps removes at least hydrogen by physical adsorption.

7. The system of claims 6, wherein each of the first set of traps has a first adsorbent surface made of carbon.

8. The system of claim 6, wherein the second set of traps removes at least xenon by chemical adsorption.

9. The system of claims 7,
wherein each of the second set of traps has a second adsorbent surface made of activated carbon, and
wherein a volume of xenon is recoverable from said second adsorbent surface.

10. The system of claim 1, further comprising one or more pumps or compressors that move gas through the system.

11. The system of claim 10, further comprising a processing unit configured to blend the flow of purified neon gas with one or more blending gases and output lasing gas.

12. The system of claim 11, further comprising a packaging unit with at least one compressor that transfers a volume of said lasing gas into at least one lasing gas storage canister.

13. The system of claim 12, wherein the at least one lasing gas storage canister comprises a plurality of first containers in parallel with a plurality of second containers.

14. The system of claim 13, wherein each of said first and second containers is independently removable.

15. A gas recycling process comprising:
moving a flow of contaminated lasing gas through a series of removal units including:
a set of filters that remove a fouling element from the flow of contaminated lasing gas;
a first set of traps that remove at least hydrogen from the flow of contaminated lasing gas; and
a second set of traps that remove at least xenon from said flow of contaminated lasing gas;
outputting a flow of purified neon gas from one of the series of removal units; and
blending the flow of purified neon gas with at least one blending gas so as to create a lasing gas.

16. The process of claim 15, wherein portions of the moving step are performed at a constant temperature and pressure.

17. The process of claim 15, wherein one filter is an acid filter configured to remove an amount of hydrochloric acid from the flow of contaminated lasing gas.

18. The process of claim 15, further comprising:
removing at least one second adsorbent surface;
exposing said surface to a temperature variation; and
capturing any xenon released from said surface.

19. The process of claim 15, further comprising packaging, with a packaging unit, a stored volume of said lasing gas in at least one lasing gas storage container.

20. The process of claim 19, further comprising:
attaching the at least one lasing gas storage container to a lasing chamber; and
moving an amount of the stored volume of lasing gas into the lasing chamber.

21. The process of claim 19, wherein the at least one lasing gas storage container is directly attachable to a lasing chamber.

22. A neon gas purification kit comprising:
a series of removal units configured to receive a flow of contaminated lasing gas and output a flow of purified neon gas, said removal units including:
a plurality of filters configured to remove fouling elements from the flow of contaminated lasing gas;
at least one first set of traps configured to remove at least hydrogen from the flow of contaminated lasing gas; and
at least one second set of traps configured to remove at least xenon from said flow of contaminated lasing gas; and
one or more moving elements configured to move said flow of contaminated lasing gas through the series of removal units, wherein each filter and trap is independently removable.

23. The kit of claim 22, comprising one or more flow meters configured to measure an amount of contaminated lasing gas flowing through each filter or trap and communicate with a third party when said measurement approaches a maximum amount.

24. The kit of claim 22, further comprising:
one or more blending gas storage canisters; and
a processing unit configured to blend the flow of purified neon gas with the blending gases contained in the one or more blending gas storage canisters so as to create a lasing gas.
